(19) United States
(12) Patent Application Publication
(10) Pub. No.: US 2013/0041523 A1
(43) Pub. Date: Feb. 14, 2013

(54) METHOD AND SYSTEM FOR PROTECITON OF SUBSEA ASSETS

(71) Applicants: Lars Mohr Jensen, Skoerping (DK); Svend Frølund, Aalborg (DK); Per Christian Engberg, Aalborg (DK)

(72) Inventors: Lars Mohr Jensen, Skoerping (DK); Svend Frølund, Aalborg (DK); Per Christian Engberg, Aalborg (DK)

(73) Assignee: GATEHOUSE A/S, Noerresundby (DK)

(21) Appl. No.: 13/635,847

(22) PCT Filed: Mar. 18, 2011
(86) PCT No.: PCT/DK2011/050086

§ 371 Date: Nov. 5, 2012

(30) Foreign Application Priority Data
Mar. 19, 2010 (DK) PA 2010 70111

(51) Int. Cl. G06F 17/00

(52) U.S. Cl. 701/1; 701/300

(57) ABSTRACT

The present invention relates to a method and a system for protection of subsea assets, which system comprises an electronic map indicating subsea assets, the system defines a geographical zone, which zone covers an area around the subsea asset, which system performs tracking of vessels entering a geographical zone by analysing electronic signal transmitted or reflected from the vessel. Performing an analysis of a sailing pattern in the geographical zone, the system can define at least one event based on sailing patterns, which system scores the events, the system count the scores, and based of a defined level of scores the system generates an alarm, based on the alarm the system generates a warning, which warning can be transmitted to the vessel. By this system there can be placed a computer system at a coast control center, where all data about vessels are picked up. This way, the system can transmit an alarm to a vessel if the vessel performs critical behaviour near subsea assets.

### BACKGROUND OF THE INVENTION

1. Field of the Invention

The present invention relates to a method for protection of subsea assets, which method comprises at least the following steps; define a protected geographical zone in relation to a subsea asset to be protected, start tracking of vessel entering the protected geographical zone.

2. Description of Related Art

The present invention further relates to a system for protection of subsea assets, which system comprises an electronic map indicating subsea assets, the system defines a geographical zone, which zone covers an area around the subsea asset, which system perform tracking of vessels entering a geographical zone by analyzing electronic signals transmitted or reflected from the vessel.

JP 7-47992 A concerns a grounding alarm in recognizing the existence of a shoal not only on a marine chart in display but on the adjacent chart as well as to make the entity of the shoal checkable earlier insofar as possible. An electronic chart coupling device selects an electronic marine chart conformed to its own ship position detected by a position detector from an electronic chart data file group, outputting it to a coordinate judger 1, and it is displayed on an electronic chart display part, while the own ship position and the travelling direction are displayed on the electronic marine chart. In addition, the electronic chart coupling device 4 selects the adjacent electronic chart, existing in a constant range in the travelling direction, from the electronic chart data file group, coupling data of an isobathic line and so on, and thereby one virtual electronic marine chart is formed. The coordinate judger 1 investigates on whether there is a shoal within the grounding dangerous range in the travelling direction of its own ship or not from the electronic marine chart formed by the electronic chart coupling device, and in the case where there is the shoal, a warning is raised by an alarm.

The SeeCoast system uses neural nets to detect anomalous vessel tracks. Moreover, they use a combination of AIS (Automatic Identification System), CCTV, and radar to construct vessel tracks, the tracks are constructed through fusion of a number of data sources.

U.S. Pat. No. 6,249,241 B1 discloses a marine Vessel Traffic System (VTS), which is an improved radar harbour surveillance sensor, computer and display system that monitors marine harbour traffic, provides advisories to vessels in areas selected by the system operators, and provide the operators of the system with an early warning of unacceptable traffic conflicts in the confined waterways of the harbour. The VTS collects harbour traffic information from multiple remote sensor collection sites around the harbour and integrates records, merges and presents the remote site data onto a single operator display, selected from a plurality of operator displays. VTS provides quick accurate computer generated graphic display of the harbour traffic, possible surface and subsurface conflicts, and key vessel identification information and the VTS documents incidents and traffic conditions for the Coast Guard or other waterway authorities.

U.S. Pat. No. 7,548,194 B2 discloses a hostile intention assessment system and method wherein a tracking sensor subsystem (e.g., radar) tracks targets relative to a critical asset. Determinations are made to assess if a first target is approaching a second target, and to assess if the second target is approaching the critical asset. If the first target is approaching the second target to hide in the radar shadow thereof and the second target is approaching sufficiently close to the critical asset, an alert is generated.

The documents cited above concerns mostly vessel safety systems. None of the documents concerns safety activity for subsea assets.

### SUMMARY OF THE INVENTION

The object of the pending application is to describe a method and a system for protecting subsea assets. A first object is to let the method and the system be proactive and warn vessel before contact and damage of the subsea assets. A further object is to warn the owner of the subsea asset. A third object of the invention is to save vessel data and actual position each time a vessel shows a critical behaviour near subsea assets.

The object of the invention can be fulfilled with a method described in the preamble to claim 1 and further comprises the following steps; detect sailing pattern of vessels in the protected geographical zone, and define events based on the sailing pattern, if one or more critical events are indicated the method activates an alarm, performs communication with the vessel, and transmits a warning to the vessel control, stores the critical event in a database and communicates with the administration of the subsea asset, and stops tracking of vessels leaving the protected geographical zone.

Hereby it can be achieved that a vessel that has an unusual behaviour in a critical zone close to subsea assets will be contacted if the behaviour of the vessel indicates that subsea activities are to start. This means e.g. the vessel is to anchor in an area where e.g. subsea cables or subsea pipelines are running. If an anchor starts dragging in e.g. a cable, this cable can very easily be damaged. The insulation of the cable can be damaged and seawater can penetrate and get into touch with conductive material inside the cable. Weeks or even years can pass before the cable is so damaged that is gives rise to failures. And in such a situation it is very time-consuming to find the leak. Maybe a cable has to be picked up from the seabed from a considerable long distance to be inspected. The inspection of finding the failure is probably the most expensive part of a repairment of a cable. As soon as the failures are indicated, the cable can be picked up at a vessel and the cable can be repaired. Quick repair is highly desirable, but avoiding damage altogether is, of course, even more desirable: downtime of a cable or pipeline implies a substantial financial loss to the pipeline owner and operator. Therefore, by the pending application we can avoid damages to subsea assets by performing a survey of vessels operating above the subsea assets. As long as vessels are just passing over at normal speed, there is no kind of difficulties if the water depth is substantially deep. In other situations where a vessel is grounding, it is critical if that grounding takes place at a subsea asset placed in shallow water. Grounding can damage pipelines and cables just as must as dragging an anchor can damage the assets. Also trawlers can damage subsea assets. A modern trawler drags a trawl which is more that 2 kilometres wide in the opening. At both sides for keeping the trawl open heavy trawl doors are used. The trawls doors have a size so big that they can damage a subsea asset in the same way as an anchor. A modern trawl door can have a weight of several tons. Therefore, also fishing boats dragging a trawl can be very critical in areas close to subsea assets.

Some of the sailing patterns that one might consider dangerous to subsea assets may constitute perfectly normal and harmless behaviour in other waters. For example, a sailing pattern that indicates impending anchoring would likely be considered dangerous if carried out in the proximity of a subsea asset, but may be perfectly normal and harmless in other contexts. Thus, part of the idea is to make the event generation context sensitive and limited to the areas that are close to subsea assets. Moreover, certain sailing patterns may be dangerous in the context of certain sections of an asset only. For example, a pipeline section in very shallow waters may be subject to damage by a grounding vessel; a pipeline section in “medium-deep” waters may be subject to damage by anchoring, but not grounding; and a pipeline section in deep waters may be subject to damage by fishing trawls only if the waters are too deep for anchoring. Finally, what is considered a potentially dangerous sailing pattern may depend on the proximity to ports and other entities: in open sea, a slow speed may indicate impending anchoring and should thus be considered a clear indication, whereas close to a port, slow speed may be perfectly normal behaviour.

The method can define a score for each event, and define the event score depending of the type of zone, and count the event score, and generate an alarm if the event score reaches a defined level. The triggering of an event may depend on a variety of different conditions, including the passage of time. For example, a grounding event may be triggered as a consequence of an abrupt change in vessel speed, combined with a subsequent lack of vessel motion. Due to the unreliable nature of tracking technology, we may sometimes wish to trigger a grounding event even if only one of these conditions is met (as far as the event-detection engine can determine). For example, if a vessel is stationery for an extended period of time, we may trigger a grounding event, even if we have not explicitly observed a sudden change in speed. To account for such cases, we use a scoring system, where each condition contributes with a weighted number of points. For example, the sudden change of speed may contribute 50 points and each minute a vessel if stationary may contribute 20 points. We can then decide to trigger grounding events if a vessel's combined grounding score exceeds 100 points.

The method can comprise the following steps for defining grounding events: measure sudden reduction in speed, where the end speed is close to zero, and measure subsequent lack of motion, the vessel is stationary for an extended period of time, and check the water depth, if shallow, and the vessel draught is close to the water depth, there can be high risk for grounding. Hereby, it is possible to send a warning to a vessel that is sailing in shallow water where there is high risk of grounding. This way, it may be possible to warn the vessel just before it hits the ground and before any damage to the subsea assets are made. Otherwise, if the grounding is detected at a position close to a subsea asset, it is highly effective that the position and maybe also the name of the vessel can be stored in a database and also transmitted immediately to the subsea assets owner. In that way, a later repair will be much easier because the position of where damage probably exists is known and will be easy to indicate. It is also possible for the owner of the subsea assets to find the vessel that has been the reason for the damage.

The method can comprise the following steps for defining anchoring events; measure low speed of a vessel in a defined period, and perform a check of the water depth, if it is possible to reach the sea bed with an anchor, there is possibility for anchoring. Hereby, it can be achieved that anchoring can at first be avoided in a defined zone around a subsea asset. If a vessel starts an anchoring procedure in a defined zone, a warning can be transmitted to the vessel. If the vessel succeeds in dropping the anchor in the zone near the subsea asset, it is also possible to warn the vessel and also to transmit the position of the vessel together with the vessel data to the owner of the subsea assets. If the vessel is receiving a warning against anchoring and the anchor has been dropped to the seabed, maybe the anchor can be pulled back onboard the vessel before the anchor starts dragging over the seabed before it is fixed maybe to a pipeline or a cable.

The method can comprise the following steps for defining trawling events; measure low steady speed of a vessel, measure stable heading, and check if the vessel is a fishing vessel. This way it can be achieved that fishing vessels that are using trawls will be warned long before the trawl reaches the subsea assets and makes any damage thereto. Probably a fishing vessel knows exactly how deep the trawl is in the water and as such a warning can indicate subsea assets far below the trawl, the vessel as such can continue without any dangerous situations occur. But it is highly effective that there is a communication with e.g. the coast control or coast guard so that the fishing vessels get the necessary information about how to pass over the subsea assets.

This invention also concerns a system as described in the preamble to the claim 6 and further modified by performing an analysis of a sailing pattern in the geographical zone, where the system defines at least one event based on sailing pattern, which system scores the events, the system counts the scores, and based on a defined level of scores the system generates an alarm, based on the alarm the system generates a warning, which warning can be transmitted to the vessel.

By this system there can be placed a computer system at a coast control, where all data from the vessels are picked up. In that way, the system can transmit an alarm to a vessel if the vessel performs critical behaviour near subsea assets. The vessels as such have no idea in damaging the subsea assets so as soon as a warning is transmitted to a vessel, the vessel will probably stop the critical behaviour and possibly find another position for anchoring. Also fishing vessels dragging a trawl will have positive benefits in listening to a warning signal simply because it is not only damage that occurs to the subsea assets but also damages the trawl as such.

Based on the alarm vessel data related to the event can be stored in a database. By storing all events in a database, it is possible to e.g. along cables or pipelines to obtain information about all events that have happened along cables or pipelines. If a failure is indicated, inspection can be performed at these positions where events have been indicated. It is much easier to inspect a few positions at cables or pipelines than e.g. to control a whole line that can be several kilometres long. Because the position data is very often based on GPS signals, the position of the vessel is known with a precision of a few metres.

Based on the alarm the system can transmit related vessel data to the administration of the subsea asset. The data which is stored can of course also immediately be transmitted to the owner of the subsea asset. If an event has happened special technical tests can be performed at e.g. communication cables to see if there has been any damage to the cables. If a damage is indicated e.g. in an isolation, it is necessary relatively fast to perform a repairment. Also if pipelines are damaged, it is necessary relatively fast to perform an inspection and repairment of a pipeline.

The system comprises a reliable event scheme. The system contains a scheme or table that comprises a number of different events. These events can have a score. The event scheme is a dynamic scheme that is continuously being developed as soon as new strange behaviours of vessels indicate new events. Also the score of the events can be adjusted.

The system comprises rules for deriving events from observed sailing patterns, and the system uses a scoring system related to the events, where each type of event condition contributes with a weighted number of points. If a vessel is stationery for an extended period of time, that may trigger a grounding event, even if there is not explicitly observed a sudden change in speed. To account for such cases, a scoring system can be used, where each condition contributes with a weighted number of points. For example, the sudden change of speed may contribute 50 points and each minute a vessel is stationary may contribute 20 points.

An alarm can be activated if the sum of weighted numbers of points reaches a defined level. The system can decide to trigger grounding events if a vessel's combined grounding score exceeds 100 points.

The system can use Automatic Identification System (AIS) Identification to track vessels. Automatic System (AIS) is one technology, which can be used for vessel tracking. Using an on-board transponder, vessels of a certain size are required by international law to periodically transmit their position, heading, and speed. In addition, vessels periodically (albeit at a lower frequency) transmit their “static” data, such as draught and type of ship.

Reception of AIS data requires a receiver within range of the on-board transponder, and should thus be considered inherently unreliable. Our event-detection logic takes intermittent reception into account.

Other embodiments may include radar or closed-circuit television (cctv) tracking.

### BRIEF DESCRIPTION OF THE DRAWINGS

FIG. 1 shows a section of a map indicating a coast line and vessels operating near the coast.

FIG. 2 shows a map with a restricted sailing area.

FIG. 3 shows a block diagram for a computer system for avoiding damages to subsea assets.

### DETAILED DESCRIPTION OF THE INVENTION

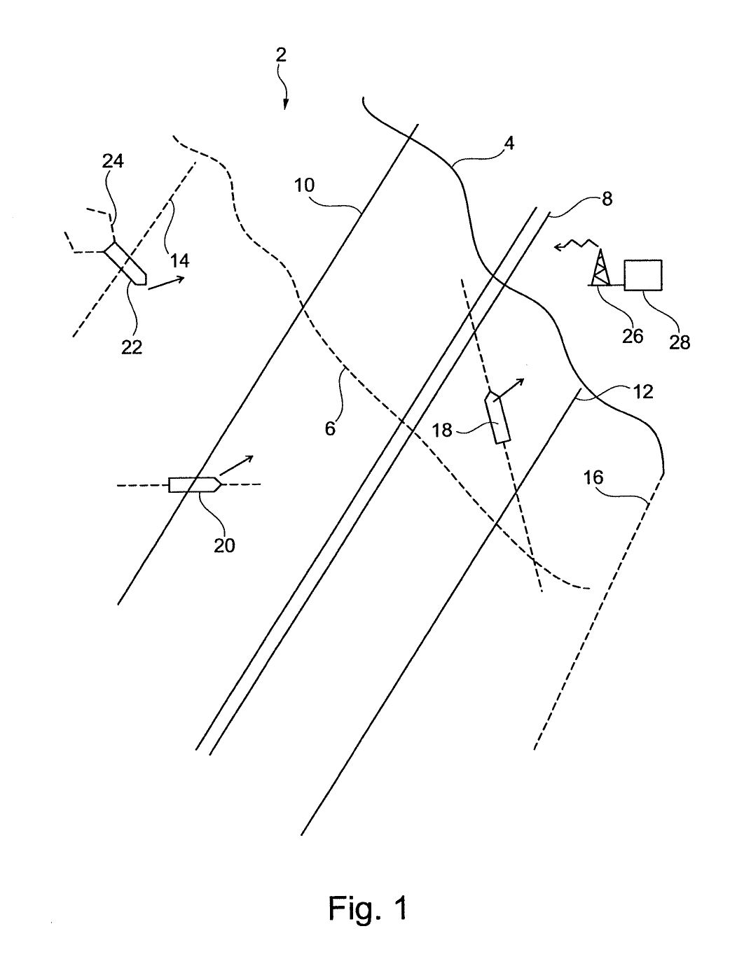

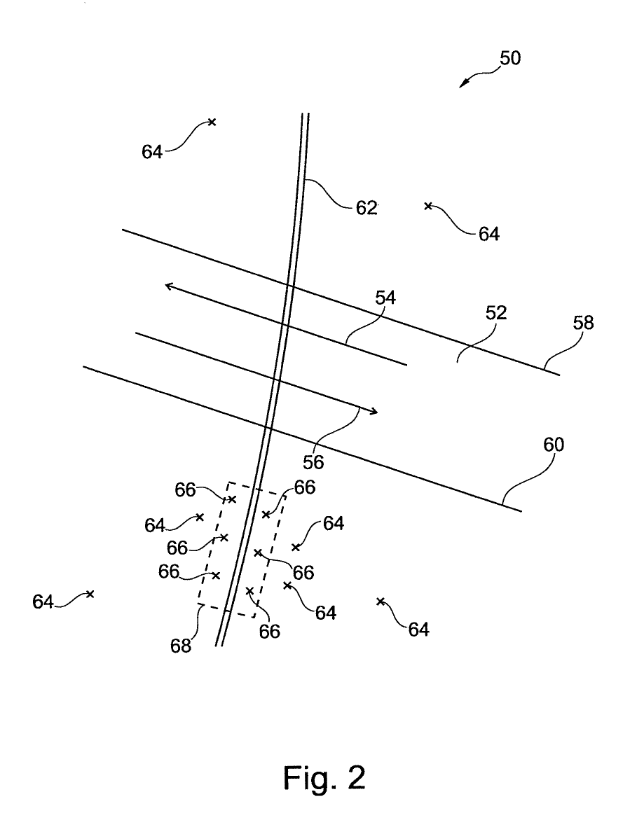

FIG. 1 shows a section of a map indicating a coast line and vessels operating near the coast. The map in FIG. 2 shows a coast line 4 and a line of deeper water 6. In FIG. 1 a pipeline or a cable 8 is indicated and a protected zone is indicated parallel to the pipeline or cable 8 which protected zone is limited by waterlines 10 and 12. Further is indicated a protected area which is limited by lines 14 to 16. Furthermore, vessels 18, 20 and 22 are indicated. The vessel 22 could be a fishing vessel dragging a trawl 24. Further is indicated a communication tower 26 and a ground based control station 28.

As seen in FIG. 1, the vessel 18 is entering the protected zone because the vessel has crossed the line 12. If the vessel 18 continues with the course indicated, the vessel 18 will hit the seabed and be grounded where there is a high risk of damaging the pipeline or cable 8. Therefore, as soon as a vessel is indicated with a critical course that is crossing the line 12, the ground based control station 28 transmits over the transmission tower 26, a warning to the vessel 18. If the vessel 18 receives a warning, it is possible for the vessel 18 to turn and avoid grounding.

Also the vessel 20 is crossing the line 10 and as such entering the protected zone. Depending on the behaviour of the vessel 20, a warning can be transmitted. In a situation where vessel 20 has a relative high speed and the vessel continues with a high speed, there is no risk of damaging the pipeline or cable 8. If the vessel 20 instead reduces speed and nearly stops, there is a high risk that the vessel 20 performs anchoring. Anchoring in the zone between the lines 10 and 12 is critical because anchors are often drawn along the seabed before the anchor is fixed into the seabed. If the anchor is picking up or pulling a pipeline or cable 8, damages on the pipeline or cable can not be avoided. If e.g. isolation is damaged on a communication cable, the cable can still be operational for a very long period. It can take weeks or maybe years before seawater penetrates the cable and disturbs the communication. Also at pipelines transporting gas or oil at high pressure or maybe high temperature, damage to the outer coating of a pipeline can lead to seawater getting in touch with the tubes and corrosion might start. This corrosion may result in the tubes start leaking. In both situations, it is not the repair of the pipeline or the cable that is expensive. It is to locate where the leak is at a cable or a pipeline that is the most expensive operation. Detailed inspection of a cable over maybe 100 kilometres is very expensive and very time-consuming. Therefore, it is very important if a system or a method as described above can avoid damages on subsea assets or at least indicate the position of an event.

The basic triggering rules for grounding events are as follows:
Sudden reduction in speed, where the end-speed is close to zero
Subsequent lack of motion—the vessel is stationary for an extended period of time
The water depth is shallow; the vessel's draught is close to the water depth

It only makes sense to evaluate these triggering rules in relatively shallow waters.

The basic triggering rules for anchoring events are as follows:
Low speed (the length of time is a compounding factor)
The water depth makes it possible to reach the seabed with an anchor
Heading is stable, and corresponds to the water current (may be hard to determine reliably at low speeds)
Heading differs substantially from course-over-ground.

As mentioned above, whether low speed in itself should be a sufficient condition to trigger an anchoring event depends on the context. In essence, low speed may be a reliable indicator of anchoring if sailing at a low speed is an anomalous behaviour in that part of the sea. In areas where low speed may be normal behaviour, more sophisticated rules are needed to complement these basic rules.

The basic triggering rules for trawling events are as follows:
Low, steady speed (the length of time is a compounding factor)
Stable heading (may be hard to determine reliably at low speeds)
The vessel is a fishing vessel

In the following a number of event are described in relation to the FIG. 1

### Grounding Events:

For a vessel 18 and grounding zone G:

INITIALLY assign 0 points to the variables stationary-score, speed-score, and ground-report.

IF Vessel 18 is inside G AND Vessel 18 suddenly reduces speed with an end-speed close to 0 AND Vessel 18's draught is close to the water depth at Vessel 18's position THEN assign S points to the variable speed-score, where S may depend on the absolute speed reduction and the length of the time interval during which the speed reduction occurred

IF Vessel 18 is inside G AND Vessel 18 is stationary for an extended period of time AND Vessel 18 draught is close to the water depth at Vessel 18 position

THEN assign T points to the variable stationary-score, where T may depend on the length of the time period during which Vessel 18 is stationary

IF Vessel 18 is inside G AND Vessel 18 reports that it is grounded

THEN assign R points to the variable ground-report, where R may depend on the reliability of the grounding indication from Vessel 18

IF Vessel 18 moves outside G

THEN assign 0 points to the variables stationary-score, speed-score, and ground-report; clear the observation history for Vessel 18 in G

IF the sum of stationary-score, speed-score, and ground-report exceeds a limit L_{G}

THEN trigger a grounding event for Vessel 18; assign 0 to the variables stationary-score, speed-score, and ground-report; clear the observation history for Vessel 18 in G

### Anchoring Events:

For a vessel 20 and an anchoring zone A:

INITIALLY assign 0 points to the variables slow-score, difference-score, and anchor-report

IF Vessel 20 is inside A AND Vessel 20 sails at an unusually low speed with a stable heading AND the water depth at Vessel 20 position allows for anchoring

THEN assign S points to the variable slow-score, where S may depend on (a) the period of time during which Vessel 20 sails unusually slow with a stable heading, (b) the speed during this period, and (c) the stability of the heading during this period

IF Vessel 20 is inside A AND Vessel 20 has a heading that is substantially different from its course-over-ground

THEN assign H points to the variable difference-score, where H may depend on the difference between the heading and course-over-ground

IF Vessel 20 is inside A AND Vessel 20 reports that it is anchored

THEN assign R points to the variable anchor-report, where R may depend on the reliability of the anchoring indication from Vessel 20

IF Vessel 20 moves outside A

THEN assign 0 points to the variables slow-score, difference-score, and anchor-report; clear the observation history for Vessel 20 in A

IF the sum of slow-score, difference-score, and anchor-report exceeds a limit L_{A}

THEN trigger an anchoring event for Vessel 20; assign 0 to the variables slow-score, difference-score, and anchor-report; clear the observation history for Vessel 20 in A

### Trawling Events:

For a vessel 22 and a trawling zone T:

INITIALLY assign 0 points to the variables steady-score and trawl-report

IF Vessel 22 is inside T AND Vessel 22 sails at low, steady speed with stable heading for an extended period of time AND Vessel 22 is a fishing vessel AND the water depth at Vessel 22 position allows for trawling

THEN assign S points to the variable steady-score, where S may depend on (a) the period of time during which Vessel 22 sails at a low, steady speed with stable heading, (b) the speed during this period, (c) the steadiness of the speed during this period, and (d) the stability of the heading during this period

IF Vessel 22 is inside A AND Vessel 22 reports that it is trawling

THEN assign R points to the variable trawl-report, where R may depend on the reliability of the trawling indication from Vessel 22

IF Vessel 22 moves outside T

THEN assign 0 points to the variables steady-score and trawl-report; clear the observation history for Vessel 22 in T

IF the sum of steady-score and trawl-report exceeds a limit L_{T}

THEN trigger a trawling event for Vessel 22; assign 0 to the variable steady-score and trawl-report; clear the observation history for Vessel 22 in T.

FIG. 2 shows a map 50 on which a restricted sailing area 52 is shown. The map could be showing a sea area with shallow waters where the sailing route 58 has been dug in order to achieve sufficiently deep waters to avoid grounding of ships. In this restricted sailing area there are probably signposts and other types of indications to be seen from the ships where 54 indicates the sailing route for ships in the first direction, and 56 indicates the sailing route for ships in the opposite direction. The restricted area 52 has restriction lines 58 and 60. In a restricted area with deep waters there is no doubt that anchoring is not allowed.

However, for example a subsea cable 62 will cross the sailing route 52. Various types of subsea events such as anchoring, trawling or grounding have been indicated as 64 on the map, but these subsea events has been established so far away from the cable or pipeline 62 that no damage could occur. Other subsea events have been indicated at the positions 66 which are rather close to the cable or pipeline 62. For all subsea events the system as such will exceed the area indicated by 68, and in such cases, the anchoring event can be saved in the computer system and as such also be communicated to the operator of the cable or pipeline 62. Therefore, if any failure occurs in the cable or pipeline, it is of course in the area 68 that a technical investigation will start, maybe underwater, or by lifting up the cable onto a ship. This way it is maybe possible to inspect only a few hundreds of metres of a cable which has indicated a defect, instead of inspecting several kilometres without any failures to find for example one anchoring 66 that has damaged the cable. Thus, the system according to the invention is highly effective, not only in order to avoid anchoring near subsea assets, but also if anchoring has occurred, the system will be capable of indicating the position of that anchoring so that inspections later on can be performed much more easily, efficiently and quickly.

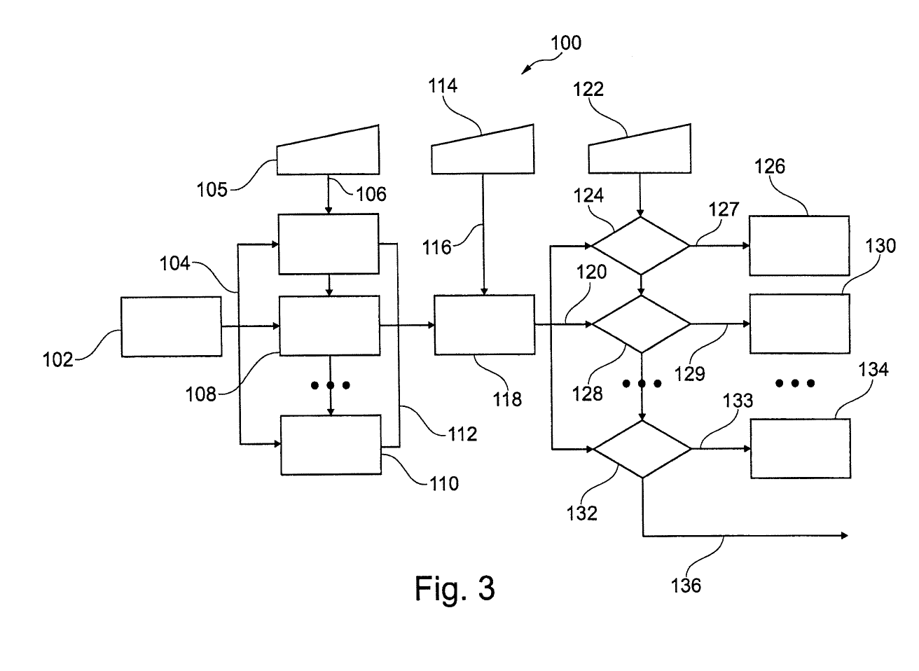

FIG. 3 shows a block diagram for a computer system for avoiding damages to subsea assets.

The block diagram at FIG. 3 indicates a system 100 which discloses a first block 102 for collection of different sensor data. These sensor data could for example be AIS, radar or space AIS or it could for example be hook-eyed cameras such as CCTV, which can supervise ships near harbours. The sensor data received in 102 is further communicated over line 104 to the blocks 106, 108 and 110. A block 105 is further communicated to the blocks 106, 108 and 110. The block 105 is storage of different data in relation to the actual placement at sea where different algorithms are stored depending on where in the world the system is to be used. The algorithms stored in the box 105 comprise in this way the characteristics of the sailing that is usually performed in a specific area. Different zones can have different algorithms. For example it is possible to sail close to a pipeline into a harbour if the sailing route and the pipeline are running in parallel. In that situation normal sailing patterns just along the pipeline will be accepted as a normal sailing behaviour. In the block 106, there could be performed an analysis of sudden speed changes of a vessel, and in the next block 108 there could be performed a measurement of the maximum time spent in a predefined zone. This way it could be indicated, for example, that a ship is starting to anchor, or it is a fishing ship that sails with a trawl active. The block 110 indicates that further investigations of different behaviours of ships based on data coming from detectors in the block 102 can be performed.

The different technical tests of indicated behaviour of ships that have been performed in the blocks 106, 108 and 110 or even in more blocks are possible. In the block 118 by an algorithm which is stored in the storage 114 which communicate over line 116 to the block 118 where a summarization is performed of the different results from the block 106 to 110. The summarization could be performed by the formula Σa*weighta+b*weightb In the block 122 are stored different actions that could be performed depending on the calculated score in the block 118. The blocks 124, 128 and 132 are performing activation depending on the score that is indicated. If the block 124 is activated it transmits a communication over line 127 to the block 126 which block 126 could transmit an AIS message to a ship. The block 128 can over communication line 129 with the block 130 tell a manual operator that a critical situation might occur in the near future. Therefore, the operator can by traditional radio communication contact the ship. By the block 132 and communication line 133, the block 134 can be activated and that activation could be a storage of an indicated event that could be used at a later moment for a statistic analysis in that area. The line 136 indicates that further communication to another computer system is possible.

Block 105, 114 and 122 hold information tailoring the system to a specific sea area. This area specific tailoring is of key importance to balance the numbers of false positive events.

1. Method for protection of subsea assets, which method comprises at least the following steps:
a: define a protected geographical zone in relation to subsea assets to be protected,
b: start tracking of vessel entering the protected geographical zone,
c: detect sailing pattern of vessels in the protected geographical zone,
d: define events based on the sailing pattern,
e. if one or more critical event is indicated the method activates an alarm,
f: perform communication with the vessel,
g. transmit a warning to the vessel control,
h. store the critical event in a database and communicate with the administration of the subsea asset,
i. stop tracking of vessels leaving the protected geographical zone.

2. Method for protection of subsea assets according to claim 1, whereby the method comprises at least the following steps:
a: define a score for each event,
b: define the event score depended of the type of zone,
c: count the event score,
d: generate an alarm if the event score reaches a defined level

3. Method for protection of sub sea assets according to claim 2, whereby the method comprises at least the following steps for defining grounding events:
a: measure sudden reduction in speed, where the end speed is close to zero,
b: measure subsequent lack of motion, the vessel is stationary for an extended period of time,
c: check the water depth, if shallow and the vessel draught is close to the water depth high risk for grounding.

4. Method for protection of sub sea assets according to claim 2, whereby the method comprises at least the following steps for defining anchoring events:
a: measure low speed in a defined period,
b: check the water depth, if it makes it possible the reach the seabed with an anchor possibility for anchoring,
c: measure heading, if stable check if the heading correspond to the water current, this indicates anchoring,
d: measure course-over-ground, if substantially different from heading, this indicates a possible emergency situation.

5. Method for protection of sub sea assets according to claim 2, whereby the method comprises at least the following steps for defining trawling events:
a: measure low steady speed,
b: measure stable heading,
c: check if the vessel is a fishing vessel.

6. System for protection of subsea assets, which system comprises an electronic map indicating subsea assets, the system defines a geographical zone, which zone covers an area around the subsea asset, which system performs tracking of vessels entering a geographical zone by analyzing electronic signal transmitted or reflected from the vessel, whereby the system performs an analysis of a sailing patterns in the geographical zone, the system defines at least one event based on sailing patterns, which system scores the events, the system counts the scores, and based of a defined level of scores the system generates an alarm, based on the alarm the system generates a warning, which warning is transmitted to the vessel.

7. System according to claim 6, whereby the system the system based on the alarm vessel data related to the event is stored in a database.

8. System according to claim 7, whereby the system based on the alarm, the system transmits related vessel data to the administration of the subsea asset.

9. System according to claim 6, whereby the system comprises a reliable event scheme.

10. System according to claim 9, whereby the system comprises rules for deriving events from observed sailing patterns, which system uses a scoring system related to the events, where each type of event condition contributes with a weighted number of points.

11. System according to claim 10, whereby an alarm is activated if the sum of weighted numbers of points reach a defined level.

12. System according to claim 10, whereby the system uses Automatic Identification System (AIS) to track vessels.
